(19) United States
(12) Patent Application Publication
(10) Pub. No.: US 2008/0023649 A1
(43) Pub. Date: Jan. 31, 2008

(54) Radiation image conversion panel and process for producing the same

(75) Inventors: Hajime Kubota, Kanagawa (JP); Ken Hasegawa, Osaka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/822,606

(22) Filed: Jul. 9, 2007

(30) Foreign Application Priority Data
Jul. 7, 2006 (JP) 2006-187429

(51) Int. Cl. B05D 5/06

(52) U.S. Cl. 250/484.4; 427/65

(57) ABSTRACT

The radiation image conversion panel includes a substrate and a phosphor layer formed on the substrate by vapor-phase deposition in a vacuum chamber, the phosphor layer being repaired for projections generated on a surface of the phosphor layer or recesses resulting therefrom. The process for producing a radiation image conversion panel forms a phosphor layer on a substrate by vapor-phase deposition in a vacuum chamber, repairs the phosphor layer for projections generated on a surface of the phosphor layer or recesses resulting therefrom and subjects the phosphor layer to a thermal treatment to obtain the radiation image conversion panel.

The entire contents of documents cited in this specification are incorporated herein by reference.

### BACKGROUND OF THE INVENTION

The present invention relates to a radiation image conversion panel that is used when a radiation image is recorded (taken) by computed radiography (CR) or the like and a process for producing the radiation image conversion panel. The present invention more particularly relates to a radiation image conversion panel capable of obtaining a high-quality image with fewer defects such as point defects that may occur due to structural defects generated on the surface of a phosphor layer made up of columnar crystals (so-called a stimulable phosphor layer), and a process for producing the radiation image conversion panel.

Upon exposure to a radiation (e.g. X-rays, α-rays, β-rays, γ-rays, electron beams, and ultraviolet rays), certain types of phosphors known in the art accumulate part of the energy of the applied radiation and, in response to subsequent application of exciting light such as visible light, they emit photostimulated luminescence in an amount that is associated with the accumulated energy. Called “storage phosphors” or “stimulable phosphors”, those types of phosphors find use in medical and various other fields.

A known example of such use is a radiation image information recording and reproducing system that employs a radiation image conversion panel having a film (or layer) of the stimulable phosphor. The system has already been commercialized by, for example, FUJIFILM Corporation under the trade name of FCR (Fuji Computed Radiography).

In that system, a subject such as a human body is irradiated with X-rays or the like to record radiation image information about the subject on the radiation image conversion panel (more specifically, the stimulable phosphor layer). After the radiation image information is thus recorded, the radiation image conversion panel is scanned two-dimensionally with exciting light such as laser light to emit photostimulated luminescence which, in turn, is read photoelectrically to yield an image signal. Then, an image reproduced on the basis of the image signal is output as the radiation image of the subject, typically to a display device such as a CRT (cathode ray tube) display or an LCD (liquid crystal display), or on a recording material such as a photosensitive material.

The radiation image conversion panel is typically prepared by the following method: Powder of a stimulable phosphor is dispersed in a solvent containing a binder and other necessary ingredients to make a coating solution, which is applied to a panel-shaped support made of glass or a resin, with the applied coating being subsequently dried.

Also known are phosphor panels which are prepared by forming a stimulable phosphor layer (hereinafter also referred to simply as a “phosphor layer”) on a support through vacuum film deposition techniques (vapor-phase film deposition techniques) such as vacuum evaporation and sputtering. The phosphor layer formed by such vacuum film deposition techniques has superior characteristics in that it is formed in vacuo and hence has low impurity levels and that being substantially free of any ingredients other than the stimulable phosphor as exemplified by a binder, the phosphor layer not only has small scatter in performance but also features very highly efficient luminescence. In addition, since the phosphor layer formed has a phosphor of a columnar structure, satisfactory image quality including high sharpness is achieved.

The radiation image conversion panel may cause defects on resulting images in the case where foreign matter such as dirt or dust adhered to the panel during the reading process, and in the case where foreign matter such as dirt or dust was incorporated in the panel during the manufacturing process. In order to suppress occurrence of such image defects, various techniques have been disclosed (see JP 5-72656 A, JP 11-344781 A and JP 2002-243859 A to be referred to below).

JP 5-72656 A discloses a radiation image reading apparatus provided with a mechanism of cleaning a stimulable phosphor sheet. The cleaning mechanism disclosed in JP 5-72656 A has a rotating cleaning roller pair and a static eliminator brush pair.

The radiation image reading apparatus of JP 5-72656 A uses the cleaning mechanism to remove foreign matter adhering to the surface of the phosphor sheet and electric charges on its surface, thus eliminating adverse effects of the electric charges or adhering dust on a resulting radiation image.

JP 11-344781 A discloses a radiation image reading apparatus in which a transport system for transporting a stimulable phosphor panel on which a radiation image has been recorded includes a plurality of elastic belts arranged so as to lie on both sides of the stimulable phosphor panel.

In the radiation image reading apparatus of JP 11-344781 A, the elastic belts are driven to transport the stimulable phosphor panel sandwiched between the elastic belts, which prevents scratching on the stimulable phosphor panel during its transport, deterioration with time due to generated distortion, and also adhesion of foreign matter such as dust or dirt to the stimulable phosphor panel during its transport. JP 11-344781 A also prevents adhesion of dirt to the phosphor layer and image deterioration that may occur during image reading.

Hillocks (abnormally projected portions) have also been conventionally known to cause such image defects. As is seen from a radiation image conversion panel 200 shown in FIG. 10, an image defect may occur due to dirt or other factor, although normally columnar crystals 206 grow to form a stimulable phosphor layer (phosphor layer) 204 whose surface 204a has a substantially uniform height.

To be more specific, if dirt 208 adheres to a substrate 202 when the phosphor layer 204 is to be formed on the substrate 202, a crystal 206a abnormally grows from the dirt 208 serving as the starting point, consequently causing a hillock Hi which projects from the surface 204a of the phosphor layer 204. The crystal 206a having abnormally grown causes a resulting image to have a point defect that an inherently black portion is rendered white. It is not always possible to produce a radiation image conversion panel with which high-quality images having fewer defects are obtained unless contamination by dirt or dust as described above is suppressed.

In order to solve such a problem, JP 2002-243859 A discloses a technique in which projections such as hillocks generated on the surface of a wavelength conversion member (so-called phosphor layer) in a radiation detector are inspected for their positions or heights and the projections are removed as required based on the results of inspection. As for the projection removal method in this technique, it is described that projections having heights exceeding a threshold value are crushed, scraped down or cut off to a predetermined height (e.g., 50 μm or less).

### SUMMARY OF THE INVENTION

The radiation image reading apparatus in JP 5-72656 A and JP 11-344781 A which are capable of removing dirt having adhered during image reading has a problem that dirt having been incorporated in the radiation image conversion panel cannot be removed.

The technique described in JP 2002-243859 A has difficulty in properly treating all the projections generated on the surface of the wavelength conversion member (phosphor layer) as will be described later, although various methods are used to adjust the heights of the projections generated on the surface of the phosphor layer to fall within a predetermined range.

In other words, the projections such as the hillocks as described above may come off during the treatment in the process after the end of vapor deposition including various treatment steps (e.g., surface cleaning or dirt removal treatment and thermal treatment), and in particular during the dirt removal treatment. In such a case, recesses (holes) are left behind in the portions of the phosphor layer surface where the projections have previously been formed.

Formation of such holes causes abrupt changes in the thickness of the phosphor layer on the peripheries thereof, which may cause the point defects as described above.

In other words, in the case where the projections such as the hillocks as described above are formed on the surface of the phosphor layer after the end of the vapor deposition, not only the projections themselves but also the recesses which are generated due to the projections having come off the phosphor layer during the various subsequent treatment steps may cause point defects.

It has been conventionally considered that individual measures need be taken to correct the defects such as the projections and the recesses which are completely different from each other at least in terms of their shapes.

More specifically, to the former defect (projections), the method as described in JP 2002-243859 A in which the projections are crushed, scraped down or cut off to reduce their heights to a predetermined value or lower is applicable, but this method was considered not to be applicable to the latter defect (recesses).

The inventors of the present invention have made an intensive study about the measures to be taken to overcome the above-mentioned situation and as a result succeeded in embodying a technique that is effective to the substantially same degree for both the former defect (projections) and the latter defect (recesses) and can prevent point defects from occurring on images. The present invention has been thus achieved.

The present invention has been made to solve the abovementioned conventional problems and an object of the present invention is to provide a radiation image conversion panel which is capable of preventing image quality from being deteriorated as in point defects that may occur on images due to projections or the like generated on the surface of a phosphor layer, or recesses left behind after the projections have come off.

Another object of the present invention is to provide a process for producing such a radiation image conversion panel with which high-quality images are obtained.

In order to attain the first object described above, a first aspect of the invention provides a radiation image conversion panel comprising a substrate, and a phosphor layer formed on the substrate by vapor-phase deposition in a vacuum chamber, the phosphor layer being repaired for projections generated on a surface of the phosphor layer or recesses resulting therefrom.

The radiation image conversion panel according to the present invention is characterized in that the projections generated on a surface of the phosphor layer and relatively small recesses resulting therefrom (in particular, recesses left behind after the projections have come off) are repaired by substantially the same process as described below.

In order to attain the second object described above, a second aspect of the invention provides a process for producing a radiation image conversion panel comprising a step of forming a phosphor layer on a substrate by vapor-phase deposition in a vacuum chamber, a step of repairing the phosphor layer for projections generated on a surface of the phosphor layer or recesses resulting therefrom, and a step of subjecting the phosphor layer to a thermal treatment to obtain the radiation image conversion panel, wherein the step of repairing is performed after the deposition is completed (prior to the thermal treatment step).

The process for producing a radiation image conversion panel according to the present invention is also characterized in that the projections generated on a surface of the phosphor layer and relatively small recesses resulting therefrom (in particular, recesses left behind after the projections have come off) are repaired by substantially the same process.

It is preferable that the process further comprises a cleaning step for cleaning (that is, dirt-removing) the surface of the phosphor layer, the formed phosphor layer being repaired before being subsequently subjected to the cleaning step after the deposition is completed. The cleaning step is performed in order to prevent the generation of new recesses which may be generated as a result of coming off of the projections. Preferably, the phosphor layer is repaired for the projections or the recesses resulting therefrom by pressing the projections or recesses from above. Needless to say, the pressure here must be a strength enough to push the projections into the phosphor layer, however, not to harm the phosphor layer itself. In particular, the pressure is preferably within the range of 0.1 to 5.0 kgf.

Preferably, the phosphor layer is repaired for the projections or the recesses resulting therefrom by using a tool whose tip portion has a curved surface. The tip portion of the tool used preferably has a hemispherical surface, and more preferably, the tip portion of the tool has a hemispherical surface with a radius of 1 mm to 10 mm.

In theory, the tool is preferably deposited such that a position of the tip portion thereof coincides with a position of a surface (average surface) of the phosphor layer at the time of pressing. However, in practice, the tip portion of the tool is constrained to somewhat plunge into the phosphor layer due to controlling reasons. Therefore, the shapes are defined as described above.

That is, in case where the tip portion of the tool does not reach to the surface of the phosphor layer, the pressure becomes undesirably insufficient. Thus, the tip portion of the tool may rather plunge into the phosphor layer for safety. When the tip portion of the tool plunges into the phosphor layer, the pressure would deform (recess) a part of the phosphor layer being vicinity of the surface. Accordingly, the above considerations with regard to the shape of the tip portion of the tool become necessary in order not to cause abrupt changes in the thickness of the phosphor layer due to the deformation.

Preferably, the phosphor layer is repaired by removing the projections and filling holes resulting therefrom (or, generated from the projections being naturally come off for some reason) with a specified filler.

Hereinafter, particularly preferable methods for repairing the phosphor layer for the recesses left behind after the projections have come off (the shapes of the recesses are generally sharp, which brings abrupt changes in the thickness of the phosphor layer) will be described.

Preferably, a certain or predetermined phosphor is used for the specified filler when the holes are filled to repair the phosphor layer.

As a material to overcome the above-described problem of the changes in the layer thickness, it is recommended to use a material having properties as close as that of the phosphor layer.

Preferably, a phosphor of a type identical to the material constituting the phosphor layer formed is used for the certain or predetermined phosphor.

The strict demand for eliminating the point defects as well as the prevention of the abrupt changes in the thickness of the phosphor layer required therefor as described above are sought because the radiation image conversion panel having a stimulable phosphor layer is for a medical use. That is, the process for producing a radiation image conversion panel according to the present invention archives a maximum effect in case where a stimulable phosphor is used.

Preferably, the specified filler is used in a powder state or in a state in which the specified filler is dissolved in a binder. Further, when the phosphor layer formed is made up of columnar crystals, a columnar crystal in another position is preferably used for the specified filler.

Those methods can be effectively used for repairing recesses (holes) formed on the phosphor layer and have respective features. Thus, it is preferable that those methods are appropriately selected in accordance with positions, numbers, sizes, depths or the like of the recesses (holes).

The radiation image conversion panel of the present invention is produced by forming a phosphor layer on a substrate by vapor-phase deposition in a vacuum chamber, then subjecting the formed phosphor layer to a thermal treatment. The radiation image conversion panel has a characteristic feature that the conversion panel is repaired for projections generated on the surface of the phosphor layer or recesses resulting therefrom and can thus prevent image quality deterioration including point defects from occurring when an image is recorded on the formed phosphor layer.

The radiation image conversion panel production process of the present invention is significantly effective in producing the radiation image conversion panel with excellent characteristics.

### BRIEF DESCRIPTION OF THE DRAWINGS

FIG. 1A is a schematic sectional view showing an embodiment of an apparatus for producing radiation image conversion panels as used in a radiation image conversion panel production process of the present invention;

FIG. 1B is a schematic side sectional view of the apparatus shown in FIG. 1A;

FIGS. 2A, 2B and 2C are a plan view, a front view and a side view schematically showing a substrate holding and transporting mechanism of the apparatus for producing radiation image conversion panels shown in FIG. 1A, respectively;

FIG. 3 is a schematic plan view showing a thermal evaporating section of the apparatus for producing radiation image conversion panels shown in FIG. 1A;

FIG. 4 is a flow diagram showing the outline of a process including a step of repairing projections or recesses resulting therefrom;

FIGS. 5A to 5D are schematic side views showing how a phosphor layer is repaired for a projection in an embodiment of the radiation image conversion panel production process;

FIGS. 6A to 6D are schematic side views showing how the phosphor layer is repaired for a recess in another embodiment of the radiation image conversion panel production process;

FIGS. 7A to 7C are schematic side views showing how the phosphor layer is repaired for a recess due to a projection in still another embodiment of the radiation image conversion panel production process;

FIG. 8A is a schematic sectional view showing a radiation image conversion panel produced by an embodiment of the radiation image conversion panel production process;

FIG. 9 is a flow diagram illustrating an overall process of producing radiation image conversion panels in the Examples; and

FIG. 10 is a schematic view illustrating occurrence of a point defect in a conventional radiation image conversion panel.

### DETAILED DESCRIPTION OF THE PREFERRED EMBODIMENTS

On the pages that follow, the radiation image conversion panel and the process for producing the radiation image conversion panel according to the present invention are described in detail with reference to the preferred embodiments depicted in the accompanying drawings.

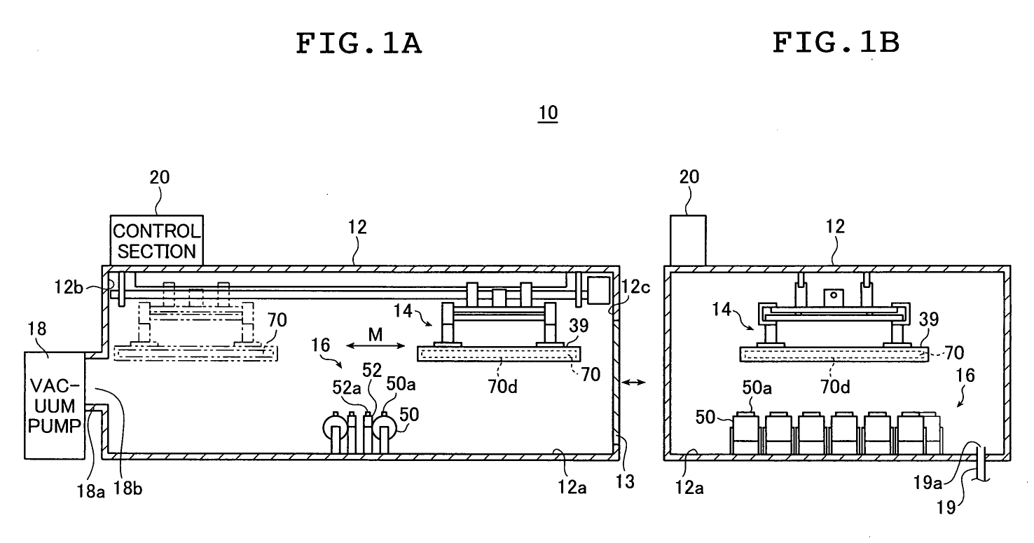

FIG. 1A is a schematic sectional view showing an exemplary apparatus for producing radiation image conversion panels as used in a radiation image conversion panel production process of the present invention. FIG. 1B is a schematic side sectional view of the apparatus for producing radiation image conversion panels shown in FIG. 1A.

In an apparatus for producing radiation image conversion panels (hereinafter also referred to simply as a “production apparatus”) 10 shown in FIGS. 1A and 1B, two-source vacuum evaporation in which a material for a stimulable phosphor (matrix) and a material for an activator are separately evaporated is applied to form a stimulable phosphor layer (hereinafter referred to as a “phosphor layer”) comprising a stimulable phosphor on a surface 70d of a substrate 70 to thereby produce a (stimulable) radiation image conversion panel.

The production apparatus 10 basically includes a vacuum chamber 12, a substrate holding and transporting mechanism 14, a thermal evaporating section (resistance heating means) 16, a vacuum pump (vacuum pumping means) 18, a gas introducing nozzle 19 and a control section 20. Needless to say, the production apparatus 10 of the embodiment under consideration may optionally have various other components of known apparatuses for vacuum evaporation. For example, the production apparatus 10 may include a vacuum gauge (not shown) for measuring the degree of vacuum within the vacuum chamber 12, which is connected to the control section 20.

In this embodiment, the substrate 70 is set in the vacuum chamber 12 for the linear transport in such a manner that a substrate holder 39 containing the substrate 70 is held by the substrate holding and transporting mechanism 14.

The substrate holder 39 is designed so that the substrate 70 is inserted from the lateral side of the substrate holder 39 in its interior, and is fitted and held in the substrate holder 39.

The apparatus of the present invention is not limited to the two-source vacuum evaporation apparatus as shown in FIGS. 1A and 1B, but may be a one-source vacuum evaporation apparatus in which all necessary film-forming materials are mixed and accommodated in evaporation sources. If desired, apparatuses capable of multi-source vacuum evaporation in which three or more components are vapor-deposited may be employed. It is preferable to use an apparatus of a type that performs multi-source vacuum evaporation in which two or more film-forming materials are accommodated in separate evaporation sources.

In a preferred version of the illustrated embodiment, cesium bromide (CsBr) serving as the phosphor component and europium bromide [EuBrₓ (x is typically 2 or 3, with 2 being particularly preferred)] serving as the activator component are used as film-forming materials and two-source vacuum evaporation is performed through resistance heating to deposit a phosphor layer of the stimulable phosphor CsBr:Eu on the substrate 70, thereby forming a radiation image conversion panel.

The production apparatus 10 having the gas introducing nozzle 19 through which an inert gas is introduced into the vacuum chamber during film deposition is preferably operated as follows: The vacuum chamber 12 is first evacuated to a high degree of vacuum and with continued evacuation, an inert gas is introduced into the vacuum chamber 12 through the gas introducing nozzle 19 until the pressure in the vacuum chamber 12 is reduced to about 0.1 Pa to 10 Pa (this degree of vacuum is hereinafter referred to as the “medium degree of vacuum”) and under this medium degree of vacuum, the film-forming materials (cesium bromide and europium bromide) are heated to evaporate through resistance heating in the thermal evaporating section 16 as the substrate 70 is transported linearly by means of the substrate holding and transporting mechanism 14 (this movement is hereinafter referred to as “linear transport”), whereby a phosphor layer is formed on the substrate 70 by vacuum evaporation.

In the present invention, various materials may be used for the stimulable phosphor constituting the phosphor layer and preferred examples are given below.

Stimulable phosphors disclosed in U.S. Pat. No. 3,859,527 are “SrS:Ce, Sm”, “SrS:Eu, Sm”, “ThO₂:Er”, and “La₂O₂S:Eu, Sm”.

JP 55-12142 A discloses “ZnS:Cu, Pb”, “BaO.xAl₂O₃:Eu (0.8≦x≦10)”, and stimulable phosphors represented by the general formula “M^{II}O.xSiO₂:A”. In this formula, M^{II} is at least one element selected from the group consisting of Mg, Ca, Sr, Zn, Cd, and Ba, A is at least one element selected from the group consisting of Ce, Tb, Eu, Tm, Pb, Tl, Bi, and Mn, and 0.5≦x≦2.5.

Stimulable phosphors represented by the general formula “LnOX:xA” are disclosed by JP 55-12144 A. In this formula, Ln is at least one element selected from the group consisting of La, Y, Gd, and Lu, X is at least one element selected from Cl and Br, A is at least one element selected from Ce and Tb, and 0≦x≦0.1.

Stimulable phosphors represented by the general formula “(Ba₁₋ₓ, M²⁺ₓ)FX:yA” are disclosed by JP 55-12145 A. In this formula, M²⁺ is at least one element selected from the group consisting of Mg, Ca, Sr, Zn, and Cd, X is at least one element selected from Cl, Br, and I, A is at least one element selected from Eu, Tb, Ce, Tm, Dy, Pr, Ho, Nd, Yb, and Er, 0≦x≦0.6, and 0≦y≦0.2.

JP 59-38278 A discloses stimulable phosphors represented by the general formula “xM₃(PO₄)₂.NX₂:yA” or “M₃(PO₄)₂.yA”. In this formula, M and N are each at least one element selected from the group consisting of Mg, Ca, Sr, Ba, Zn, and Cd, X is at least one element selected from F, Cl, Br, and I, A is at least one element selected from Eu, Tb, Ce, Tm, Dy, Pr, Ho, Nd, Yb, Er, Sb, Tl, Mn, and Sn, 0≦x≦6, and 0≦y≦1.

Stimulable phosphors are represented by the general formula “nReX₃.mAX′₂:xEu” or “nReX₃.mAX′₂:xEu, ySm”. In this formula, Re is at least one element selected from the group consisting of La, Gd, Y, and Lu, A is at least one element selected from Ba, Sr, and Ca, X and X′ are each at least one element selected from F, Cl, and Br, 1×10⁻⁴<x10⁻¹, 1×10⁻⁴<y<1×10⁻¹, and 1×10⁻³<n/m<7×10⁻¹.

Alkali halide-based stimulable phosphors represented by the general formula “M^{I}X.aM^{II}X′₂.bM^{III}X″₃:cA” are disclosed by JP 61-72087 A. In this formula, M^{I} represents at least one element selected from the group consisting of Li, Na, K, Rb, and Cs. M^{II} represents at least one divalent metal selected from the group consisting of Be, Mg, Ca, Sr, Ba, Zn, Cd, Cu, and Ni. M^{III} represents at least one trivalent metal selected from the group consisting of Sc, Y, La, Ce, Pr, Nd, Pm, Sm, Eu, Gd, Tb, Dy, Ho, Er, Tm, Yb, Lu, Al, Ga, and In. X, X′, and X″ each represent at least one element selected from the group consisting of F, Cl, Br, and I. A represents at least one element selected from the group consisting of Eu, Tb, Ce, Tm, Dy, Pr, Ho, Nd, Yb, Er, Gd, Lu, Sm, Y, Tl, Na, Ag, Cu, Bi, and Mg, 0≦a<0.5, 0≦b<0.5, and 0<c≦0.2.

Stimulable phosphors represented by the general formula “(Ba₁₋ₓ, M^{II}ₓ)F₂.aBaX₂:yEu, zA” are disclosed by JP 56-116777 A. In this formula, M^{II} is at least one element selected from the group consisting of Be, Mg, Ca, Sr, Zn, and Cd, X is at least one element selected from Cl, Br, and I, A is at least one element selected from Zr and Sc, 0.5≦a≦1.25, 0≦x≦1, 1×10⁻⁶≦y≦2×10⁻¹ and 0<z≦1×10⁻².

Stimulable phosphors represented by the general formula “M^{III}OX:xCe” are disclosed by JP 58-69281 A. In this formula, M^{III} is at least one trivalent metal selected from the group consisting of Pr, Nd, Pm, Sm, Eu, Tb, Dy, Ho, Er, Tm, Yb, and Bi, X is at least one element selected from Cl and Br, and 0≦x≦0.1.

Stimulable phosphors represented by the general formula “Ba₁₋ₓMₐLₐFX:yEu²⁺” are disclosed by JP 58-206678 A. In this formula, M is at least one element selected from the group consisting of Li, Na, K, Rb, and Cs, L is at least one trivalent metal selected from the group consisting of Sc, Y, La, Ce, Pr, Nd, Pm, Sm, Gd, Tb, Dy, Ho, Er, Tm, Yb, Lu, Al, Ga, In, and Tl, X is at least one element selected from Cl, Br, and I, 1×10⁻²≦x≦0.5, 0≦y≦0.1, and a is x/2.

Stimulable phosphors represented by the general formula “M^{II}FX.aM^{I}X′.bM′^{II}X″₂.cM^{III}X₃.xA:yEu²⁺” are disclosed by JP 59-75200 A. In this formula, M^{II} is at least one element selected from the group consisting of Ba, Sr, and Ca, M^{I} is at least one element selected from Li, Na, K, Rb, and Cs, M′^{II} is at least one divalent metal selected from Be and Mg, M^{III} is at least one trivalent metal selected from the group consisting of Al, Ga, In, and Tl, A is a metal oxide, X, X′, and X″ are each at least one element selected from the group consisting of F, Cl, Br, and I, 0≦a≦2, 0≦b≦1×10⁻², 0≦c≦1×10⁻², and a+b+c≧10⁻⁶, 0≦x≦0.5, and 0≦y≦0.2.

Alkali halide-based stimulable phosphors disclosed by JP 61-72087 A are preferred because they have excellent photostimulated luminescence characteristics and the effects of the present invention are advantageously obtained. Alkali halide-based stimulable phosphors in which M^{I} contains at least Cs, X contains at least Br, and A is Eu or Bi are more preferred, with a stimulable phosphor represented by the general formula “CsBr:Eu” being particularly preferred.

The vacuum chamber 12 of the embodiment under consideration may be any known vacuum chamber (e.g. bell jar or vacuum vessel) that is formed of iron, stainless steel, aluminum, etc. and which is employed in apparatuses for vacuum evaporation.

The vacuum pump 18 is connected to a lateral surface 12b of the vacuum chamber 12 through a diffuser 18a. For example, an oil diffusion pump is used for the vacuum pump 18. Various types as used in vacuum evaporation apparatuses may be employed for the vacuum pump 18 without any particular limitation as long as a requisite ultimate degree of vacuum can be attained. For example, a cryogenic pump and a turbo-molecular pump may be used optionally in combination with a cryogenic coil. In the production apparatus 10 intended to form the phosphor layer, the ultimate degree of vacuum to be attained in the vacuum chamber 12 is preferably 8.0×10⁻⁴ Pa or higher.

A lateral surface 12c of the vacuum chamber 12 opposite from the lateral surface 12b has a door 13 that may be opened as desired.

In this embodiment, the door 13 is opened to carry the substrate 70 and the film-forming materials into the vacuum chamber 12. The door 13 is shut to close the vacuum chamber 12 to carry out vacuum evaporation.

The gas introducing nozzle 19 is also a known gas-introducing means that has a means of connection to a cylinder as well as a means for regulating the gas flow rate (the nozzle may alternatively be connected to those means), and which is conventionally employed in apparatuses for vacuum evaporation, sputtering, etc. In order to form a phosphor layer by vacuum evaporation under the medium degree of vacuum, an inert gas or rare gas such as argon or nitrogen gas is introduced into the vacuum chamber 12 through the nozzle 19. The inert gas is a gas that does not react with the materials of the substrate 70 and the phosphor layer during vacuum evaporation.

The inert gas is introduced into the vacuum chamber 12 through an opening (gas introduction opening) 19a of the gas introducing nozzle 19. The gas introducing nozzle 19 (or its opening 19a) is provided in a bottom surface 12a of the vacuum chamber 12 in the vicinity of the thermal evaporating section 16.

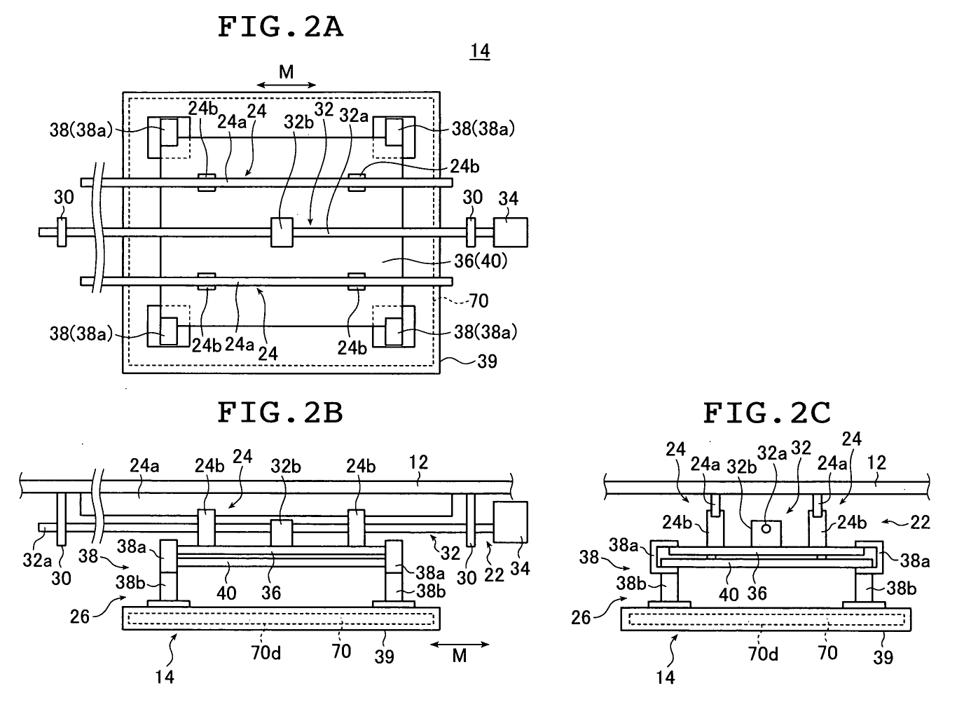

The substrate holding and transporting mechanism 14 holds the substrate holder 39 into which the substrate 70 is inserted and linearly transports it. As schematically shown in FIGS. 2A-2C, the substrate holding and transporting mechanism 14 includes a drive means 22, two linear motor guides 24 and a substrate holding means 26. FIGS. 2A, 2B and 2C are, respectively, a plan view, a front view and a side view schematically showing the substrate holding and transporting mechanism 14 of the apparatus for producing radiation image conversion panels as shown in FIG. 1A.

The drive means 22 is used to move the substrate holding means 26 to and fro in directions M in which the substrate 70 is transported. The drive means 22 is a known mechanism for effecting linear movement by making use of a ball screw, and includes a ball screw 32 having a screw shaft 32a which extends in the directions of transport M of the substrate 70 and axially supported by holding members 30 to be rotatable and a nut 32b engaged with the screw shaft 32a, and a motor 34 for rotating the screw shaft 32a.

The drive means making use of the ball screw 32 and the motor 34 is not the sole case of the present invention, but various other known means for linear movement (transport) as exemplified by a transport means using a cylinder, and a transport means using a motor and a ring-like chain rotated by the motor may be used as long as the transport means used has required thermal resistance.

The linear motor guides (hereinafter referred to as the “LM guides”) 24 are known linear motor guides assisting the linear transport of the substrate holding means 26 (i.e., the substrate 70) by means of the drive means 22, and each include a guide rail 24a and two engaging members 24b engaged with the guide rail 24a so as to be movable in the longitudinal direction.

The two guide rails 24a extend in the directions of transport M of the substrate 70, and are spaced apart from each other with respect to the screw shaft 32a and fixed to the ceiling of the vacuum chamber 12. On the other hand, the four engaging members 24b are fixed to the substrate holding means 26 (upper surface of a base 36 to be described later) such that two of the engaging members 24b are engaged with one of the guide rails 24a.

The substrate holding means (hereinafter also referred to simply as the “holding means”) 26 which holds the substrate 70 accommodated in the substrate holder 39 is linearly moved by the drive means 22 while being guided by the LM guides 24. The substrate holding means 26 includes the base 36, a holding mechanism 38 and a heat insulating member 40.

The base 36 is a rectangular plate which is horizontal when the production apparatus 10 is properly installed.

The nut 32b of the ball screw 32 is fixed to the upper surface of the base 36 at its center. The engaging members 24b of the LM guides 24 are fixed to the upper surface of the base 36 at symmetrical positions on the two diagonals as determined by the distance between the two guide rails 24a.

The holding means 38 includes four attachment members 38a and four holding members 38b, which are disposed at corners of the base 36, respectively.

The attachment member 38a is a member having a substantially C-shaped section. The attachment member 38a is inserted from the outside in a direction perpendicular to the directions of transport M with the open side in the C-shaped section directed inward such that part of the upper portion in the C-shaped member is attached at the corner of the base 36. The attachment member 38a is thus fixed to the base 36 so as to be suspended therefrom. Therefore, a larger space than the area of the base 36 is provided below the base 36 of the holding means 26.

The holding member 38b has at its lower end a means for holding the substrate holder 39 (substrate 70) and is fixed to the attachment member 38a so as to be suspended therefrom. In other words, the holding mechanism 38 for holding the substrate holder 39 (substrate 70) is suspended from the base 36 in the vicinities of its corners.

In the embodiment under consideration, there is no particular limitation on the method of holding the substrate holder 39 (substrate 70) with the holding members 38b, but various known methods of holding a plate from its upper surface side such as a method using a tool, a method using static electricity, and a method using suction may be employed. If the region of the substrate 70 where the phosphor layer is to be vapor-deposited permits, a means for holding four corners or four sides of the substrate holder 39 (substrate 70) from below by using a tool or the like may be employed.

A method in which a spacer is inserted between the attachment member 38a and the holding member 38b, a method in which an adjusting means using screws is provided, and a method in which an ascending/descending means depending on a cylinder is provided may be employed such that the lower end position of the holding member 38b, that is, the height at which the substrate 70 is held and transported can be adjusted.

As described above, the base 36 is linearly transported by the drive means 22. Therefore, in the substrate holding and transporting mechanism 14, the holding means 26 is transported by the drive means 22 while the holding mechanism 38 holds the substrate holder 39 (substrate 70), for example, in the vicinities of the four corners, whereby the substrate 70 is linearly transported together with the substrate holder 39.

The phosphor layer of the radiation image conversion panel intended to read a radiation image with a line sensor or the like requires uniformity in the film thickness distribution as high as within ±3% and preferably within ±2%.

In the embodiment under consideration, the phosphor layer is formed by vacuum evaporation under the medium degree of vacuum through resistance heating while the substrate 70 is linearly transported as described above, whereby the phosphor layer formed has excellent crystallinity and is highly uniform in film thickness distribution.

When the phosphor layer of any one of the aforementioned various stimulable phosphors which is advantageously formed by the production process of the present invention, particularly the phosphor layer of an alkali halide-based stimulable phosphor, and more particularly the phosphor layer of a stimulable phosphor represented by CsBr:Eu is to be formed by vacuum evaporation, a preferred procedure includes first evacuating the system to a high degree of vacuum, then introducing an inert gas such as argon gas or nitrogen gas into the system with continued evacuation to achieve a degree of vacuum between about 0.1 Pa and about 10 Pa and particularly about 0.5 Pa and about 3 Pa, thereby forming the phosphor layer under such medium degree of vacuum.

The thus formed phosphor layer has a satisfactory columnar crystal structure, which enables a radiation image conversion panel produced to have satisfactory photostimulated luminescence characteristics and provide excellent image sharpness.

The production apparatus 10 of this embodiment basically forms the phosphor layer under such medium degree of vacuum, and vacuum evaporation is carried out through resistance heating under the medium degree of vacuum while introducing an inert gas into the vacuum chamber 12 through the gas introducing nozzle 19 (its opening 19a).

In the production apparatus 10 of this embodiment, the phosphor layer is formed by vacuum evaporation while the substrate 70 is linearly transported in the state in which it is accommodated in the substrate holder 39, so the speed of movement of the substrate 70 can be made uniform over the whole surface thereof.

More specifically, the substrate 70 can be uniformly exposed to vapors of the film-forming materials over the entire surface merely by making uniform the amounts of the film-forming materials evaporated in a direction H perpendicular to the directions of transport M. The phosphor layer with highly uniform film thickness distribution can also be formed by simply setting the positions of the evaporation sources. In addition, film deposition during the transport by linear reciprocation enables europium (activator) which is a trace component to be suitably dispersed in the phosphor layer.

In the present invention, as long as the phosphor layer having a required thickness can be formed, film deposition may be carried out during one linear movement, or one or more reciprocating movements of the substrate 70. The substrate may be transported along a more or less zigzag or undulating path as long as the path is substantially linear.

In general, given the same thickness, the greater the number of passes over the thermal evaporating section 16, the higher the uniformity that can be attained in thickness distribution; hence, it is preferred to form a phosphor layer by reciprocating the substrate a plurality of times. The number of reciprocating movements may be determined as appropriate for the desired thickness of the phosphor layer, the desired uniformity in the film thickness distribution, and other factors, and the last transport may be made only in one direction. The speed in the linear transport may also be determined as appropriate for the limits of transport speed that are rated for the LM guides, the number of reciprocating movements, the desired thickness of the phosphor layer, and other factors.

In the holding means 26 for holding the substrate holder 39 (substrate) 70, the heat insulating member 40 is provided under the base 36 to the upper surface of which the nut 32b of the ball screw 32 and the engaging members 24b of the LM guides 24 are fixed. As described above, the production apparatus 10 of the illustrated case uses the substantially C-shaped attachment members 38a to fix the holding members 38b in a state in which the holding members 38b are suspended from the base 36, thereby providing a larger space under the base 36 than in the base 36. In the illustrated embodiment, this layout enables the heat insulating member 40 to have a larger area than that of the substrate 36 to entirely cover the lower surface of the base 36 with a sufficient margin.

The heat insulating material 40 shields the base 36 against the thermal evaporating section 16 (evaporation sources) to be described later to keep the engaging members 24b of the LM guides 24 and the nut 32b of the ball screw 32 from being heated due to heat of radiation from the thermal evaporating section 16.

As is clear from the above description, it is necessary to perform vacuum evaporation through resistance heating under the medium degree of vacuum as the substrate holder 39 (substrate 70) is linearly transported, in order to produce the radiation image conversion panel that has a sufficient crystal structure to achieve high photostimulated luminescence characteristics and image sharpness and a sufficiently high uniformity in film thickness to enable high-precision reading of radiation image with a line sensor.

As is well known, a ball is incorporated into each of the engaging members 24b of the LM guides 24 and the nut 32b of the ball screw 32 to enable smooth movement and a lubricant such as grease is injected thereinto to enable smooth rotation of the ball. Even in the case where no ball is used, a lubricant such as grease is usually injected into the sliding portions of the drive means and a transport guide means to enable smooth driving.

Various members may be used for the heat insulating member 40 without any particular limitation as long as the engaging members 24b and the nut 32b and optionally the base 36 are shielded against the heat of radiation from the thermal evaporating section 16 to be prevented from being heated. Exemplary members that may be used include a stainless steel plate, a steel plate, an aluminum plate, and a molybdenum plate. The fixing method may be determined as appropriate for the heat insulating member 40 used.

Means for cooling the heat insulating member 40 such as a means in which cooling water is allowed to flow through a pipe contacting the heat insulting member 40, and a means in which water is allowed to flow through a hole formed in the plate (heat insulating member 40) may be provided as required.

As described above, in the illustrated preferable embodiment, the heat insulating member 40 has a larger area than the base 36 and is disposed so as to cover the whole lower surface of the base 36 to which the engaging members 24b of the LM guides 24 and the nut 32b of the ball screw 32 are fixed. However, this is not the sole case of the present invention and the regions corresponding to the engaging members 24b of the LM guides 24 or the region corresponding to the nut 32b of the ball screw 32 may only be covered with a member for insulating against the thermal evaporating section 16.

Nevertheless, in order to advantageously prevent the engaging members 24b and the nut 32b from being heated, it is preferable to cover a member that may transmit heat to these components with the heat insulating member 40 to insulate them against the thermal evaporating section 16 as much as possible.

Referring to FIGS. 1A and 1B again, the thermal evaporating section 16 is provided in the lower part of the vacuum chamber 12.

The thermal evaporating section 16 is a site where the film-forming materials such as cesium bromide and europium bromide to form the phosphor layer are evaporated by resistance heating. The film-forming materials are heated to evaporate in the thermal evaporating section 16 to form the vapor deposition area including vapors of cesium bromide and europium bromide (film-forming materials in the form of vapor).

As described above, the production apparatus 10 preferably performs two-source vacuum evaporation in which cesium bromide as the phosphor component and europium bromide as the activator component are independently heated to evaporate. Therefore, the thermal evaporating section 16 is provided with crucibles (vessels) 50 serving as evaporation sources of cesium bromide (phosphor) and crucibles (vessels) 52 serving as evaporation sources of europium bromide (activator).

Like crucibles employed in ordinary vacuum evaporation that depends on resistance heating, the crucibles 50 and 52 are formed of high-melting point metals such as tantalum (Ta), molybdenum (Mo) and tungsten (W) and supplied with electricity from electrodes (not shown) to generate heat by themselves so that the film-forming materials with which the crucibles are filled are heated/melted to evaporate.

In the present invention, the power supply for resistance heating (heating control means) is not particularly limited but various systems as used in resistance heating devices may be used as exemplified by a thyristor system, a DC system, and a thermocouple feedback system. There is also no particular limitation on the power to be output in resistance heating, but the power may be determined as appropriate for the film-forming material used, electric resistance of the film-forming material in the crucible, and the amount of heat generated.

In the storage phosphor, the proportions of the activator and the phosphor are such that the greater part of the phosphor layer is assumed by the phosphor, as exemplified by a molarity ratio ranging from about 0.0005/1 to about 0.01/1.

Therefore, in the illustrated case, a cylindrical (drum-shaped) large crucible is used for the crucible 50 from which cesium bromide (phosphor) is evaporated (consumed) in a large amount. The crucible 50 has a slit opening that is provided on the lateral surface of the drum-shaped crucible so as to extend parallel to the axis of the drum-shaped crucible. A chimney 50a in the shape of a quadrangular prism is fixed at the opening as a vapor-emitting portion. The chimney has an upper and a lower opening which has the same shape as that of the slit opening.

On the other hand, a crucible type evaporation source for vacuum evaporation CE-2 manufactured by Japan Vacs Metal Co., Ltd. is used for the crucible 52 from which europium bromide (activator) is evaporated (consumed) in a small amount. Tantalum is used for the material of the crucible. The crucible has a structure in which the outer periphery of the tantalum member is covered with a heater whose outer periphery is then covered with alumina as a heat insulating material. The crucible is heated by an indirect heating system.

An advantage of the crucibles having such slit-like chimneys is that when bumping occurs on account of local heating or abnormal heating in the crucibles, abrupt gushing of the film-forming materials from within the crucibles and the adhesion of the gushed film-forming materials to the surrounding area and the substrate 70 can be prevented, thus ensuring that there will be no contamination of the surrounding areas and the substrate 70. The beneficial effect of this feature is particularly significant when vacuum evaporation is performed by resistance heating under the medium degree of vacuum, because there is a need to bring the substrate 70 close enough to the evaporation sources as described above.

In the production apparatus 10, the crucibles 50 and the crucibles 52 are arranged in a plurality of rows in the direction H perpendicular to the directions of transport M of the substrate 70 (hereinafter the direction H is referred to as the “direction of arrangement H”) to make the amounts of the film-forming materials evaporated uniform in the direction of arrangement H such that the vapors of the film-forming materials are uniformly supplied to the whole surface of the substrate 70 being linearly transported, thus forming a phosphor layer in which the uniformity in the thickness distribution is, for example, within ±3%. The crucibles are thermally insulated from each other by spacing them apart from each other or inserting an insulating material in the spaces between adjacent crucibles.

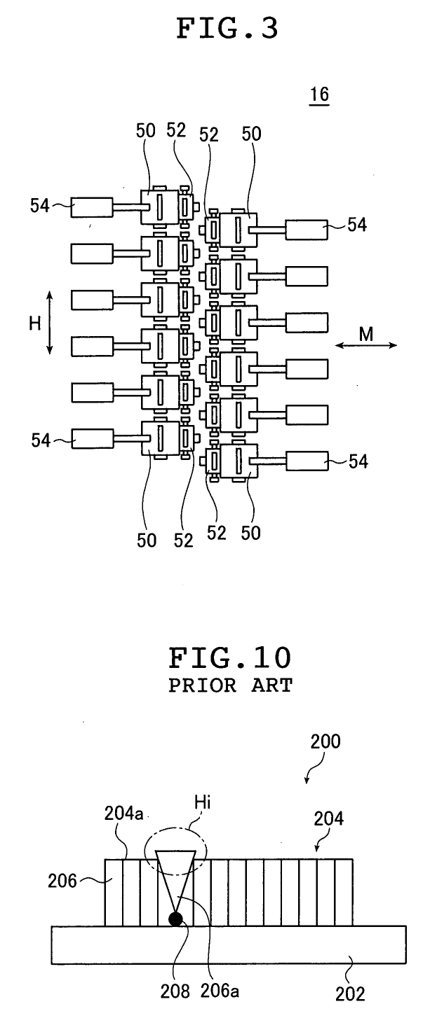

FIG. 3 shows a schematic plan view of the thermal evaporating section 16. In the example shown in FIG. 3, the crucibles 50 for cesium bromide are arranged in the direction of arrangement H parallel to the axial direction of the cylinder (drum) and the number of the crucibles 50 arranged is six. Each of the crucibles 50 has electrodes which are formed at the end faces of the cylinder and independently connected to the power supply. A quartz crystal sensor 54 for measuring the amount of cesium bromide evaporated is provided for each of the crucibles 50 (not shown in FIGS. 1A and 1B for clarifying the entire layout of the apparatus). The amount of current to be applied to the crucible 50 is controlled based on the measurement result of the amount of evaporation. The amount of evaporation may be controlled with a temperature sensor.

On the other hand, the crucibles 52 for europium bromide are boat-type crucibles and are arranged with the longitudinal direction in agreement with the direction of arrangement H. The number of the crucibles 52 is also six. Each of the crucibles 52 has electrodes which are formed at both ends in the direction of arrangement H and independently connected to the power supply.

In the illustrated preferred embodiment, one crucible 50 and one crucible 52 make a pair, in other words, one evaporation source for cesium bromide which is the film-forming material as the phosphor component and one evaporation source for europium bromide which is the film-forming material as the activator component make a pair, and the two crucibles in the pair are arranged to align in the directions of transport M of the substrate M. The crucibles in the pair are more preferably disposed so as to be the closest possible to each other in terms of the layout of the apparatus and crucibles.

Such a layout enables the vapor of europium bromide to be fully dispersed in the vapor of cesium bromide constituting the matrix so that europium (activator) which is a trace component is uniformly dispersed in the phosphor layer, and the thus formed phosphor layer can be excellent in photostimulated luminescence and other characteristics.

With regard to the row of the crucibles 50 and the row of the crucibles 52, in terms of the layout of the apparatus and crucibles, it is preferable that the crucibles in one row be arranged in the direction of arrangement H so as to be the closest possible to each other and that the crucible row have enough length to cover the size of the substrate 70 in the direction of arrangement H.

Such a layout enables the amounts of vapors of the film-forming materials to be made uniform in the direction of arrangement H, thus forming a phosphor layer having higher uniformity in film thickness distribution.

The crucibles for each film-forming material may be arranged in the direction of arrangement H in one row, in two rows as in the illustrated case, or in three or more rows.

In the case where there are two or more crucible pair rows, each crucible pair row is preferably arranged such that, when viewed from the directions of transport M of the substrate 70, outlets of the vapors of the film-forming materials (the abovementioned slit-like chimneys) in one crucible pair row fill the gaps between adjacent vapor outlets of the adjacent crucible pair row in the direction of arrangement H. It is more preferable to arrange the crucible pair rows such that the outlets of the vapors of the film-forming materials in different crucible pair rows do not overlap each other when viewed from the directions of transport M. In other words, it is preferable for the outlets of the vapors of the film-forming materials in the respective crucible pair rows to be arranged in a staggered manner when viewed from the directions of transport M. In the illustrated case, the two crucible pair rows are arranged in the direction of arrangement H such that, when viewed from the directions of transport M, the vapor outlets in one crucible pair row are disposed at the positions corresponding to the positions where the other crucible pair row has the electrodes.

Such a layout enables the amounts of vapors of the film-forming materials to be made uniform in the direction of arrangement H, thus forming a phosphor layer having higher uniformity in film thickness distribution.

In the case where there are two or more crucible pair rows in the direction of arrangement H, it is preferable for the rows of crucibles 50 from which a large amount of cesium bromide (phosphor) evaporates to be disposed outside with respect to the directions of transport M.

In such a layout, the sensors 54 for detecting the amount of cesium bromide evaporated in a large amount can be disposed in the space outside the crucible pair rows with respect to the directions of transport M. In other words, it is possible to increase the degree of flexibility in selecting the sensor for detecting the amount of evaporation and in designing the production apparatus 10.

Although not shown, in the thermal evaporating section 16 of the production apparatus 10, a quadrangular prism-shaped heat insulating member having a height exceeding the uppermost portions of the crucibles is disposed so as to surround all the crucibles from the four horizontal directions. The upper side of the heat insulating member is provided with a shutter (not shown) for shielding the substrate against the vapors of the film-forming materials and can be closed or opened as desired by means of the shutter.

In the embodiment under consideration, the substrate 70 is a thin plate member or a sheet member made of, for example, a metal or an alloy. The material of the substrate 70 is not particularly limited but, for example, aluminum, aluminum alloy, iron, stainless steel, copper, chromium or nickel may be used. The substrate 70 in this embodiment is preferably made of aluminum or an aluminum alloy.

All types of materials for sheet-shaped substrates used in radiation image conversion panels such as glass, ceramics, carbon, PET (polyethylene terephthalate), PEN (polyethylene naphthalate), and polyamide may be used for the substrate 70.

Next, the steps of the radiation image conversion panel production process in an embodiment of the invention that uses the production apparatus 10 are described in detail.

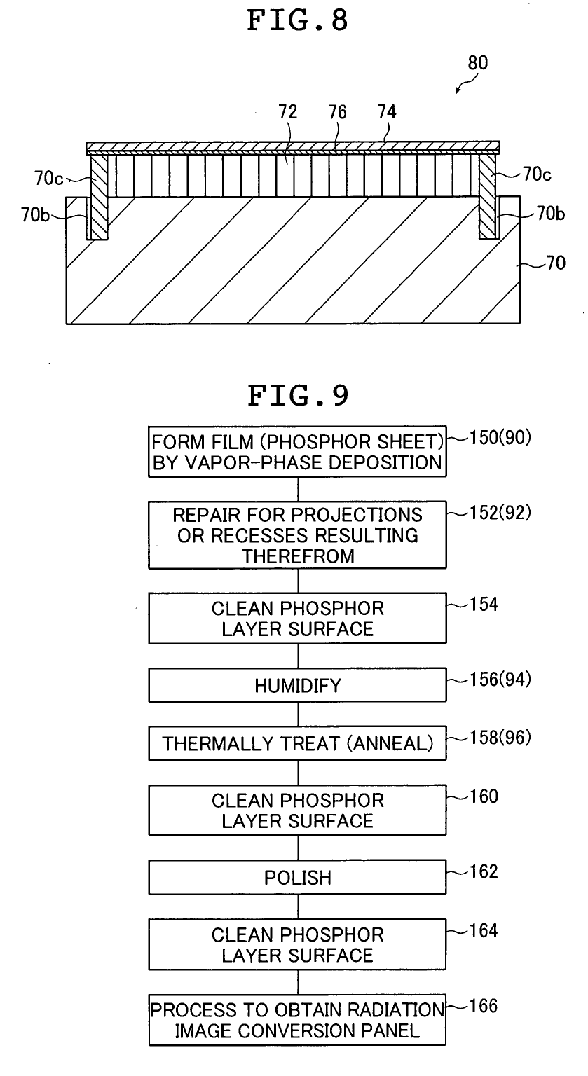

In the radiation image conversion panel production process of the embodiment under consideration, a radiation image conversion panel 80 as shown in FIG. 8 that includes a substrate 70, a phosphor layer 72 formed on the substrate 70, and a moisture-proof protective layer 74 formed on the phosphor layer 72 to hermetically seal it is finally produced. In the previous step, the phosphor layer 72 is first formed on the substrate 70.

The substrate 70 is set in advance in the substrate holder 39 (see FIG. 1A).

Then, the substrate 70 accommodated in the substrate holder 39 is set in a plasma cleaner (not shown) to perform plasma cleaning of the surface 70d of the substrate 70 on which the phosphor layer 72 is to be formed.

Then, the door 13 of the vacuum chamber 12 is opened to the atmosphere, and the substrate holder 39 containing the substrate 70 is held by the holding members 38b of the holding means 26 (see FIG. 2B) of the substrate holding and transporting mechanism 14.

Then, all the crucibles 50 are loaded with a predetermined amount of cesium bromide whereas all the crucibles 52 are loaded with a predetermined amount of europium bromide, in other words, the film-forming materials are set in the vacuum chamber 12; thereafter, the shutter (not shown) is closed.

Then, the vacuum pump 18 is activated to evacuate the vacuum chamber 12; at the time when the pressure in the vacuum chamber 12 has reached a predetermined value, say, 8×10⁻⁴ Pa, for example, argon gas is introduced into the vacuum chamber 12 through the opening 19a of the gas introducing nozzle 19 with the evacuating process being continued such that the pressure in the vacuum chamber 12 is adjusted to, for example, 1.0 Pa; thereafter, the power supply for resistance heating is turned on so that an electric current is applied to all the crucibles 50 and 52 to heat the film-forming materials.

After the lapse of a preset period of time (e.g., 60 minutes), the shutter is opened; then, the motor 34 is driven to start linear transport of the substrate 70 at a predetermined speed to thereby start the formation of the phosphor layer 72 on the surface 70d of the substrate 70.

When a specified number of reciprocating movements of the substrate 70 for its linear transport as determined in accordance with such factors as the thickness of the phosphor layer 72 to be formed have completed, the substrate 70 is brought to a stop, the shutter is closed, the power supply for resistance heating is turned off, and the supply of argon gas through the gas introducing nozzle 19 is stopped.

Then, nitrogen gas or dry air is introduced into the vacuum chamber 12 to restore the atmospheric pressure; that is, the vacuum chamber 12 is opened to the atmosphere.

Then, the door 13 of the vacuum chamber 12 is opened to take out the substrate 70 having the phosphor layer 72 formed thereon, with the substrate 70 accommodated in the substrate holder 39, and carry it to the workbench.

As described above, the characteristic operation in the radiation image conversion panel production process in this embodiment is to repair the phosphor sheet for projections or recesses resulting from such projections before the substrate 70 on which the phosphor layer 72 has been formed, in other words, the phosphor sheet (substrate having the phosphor layer formed thereon) is subjected to a thermal treatment.

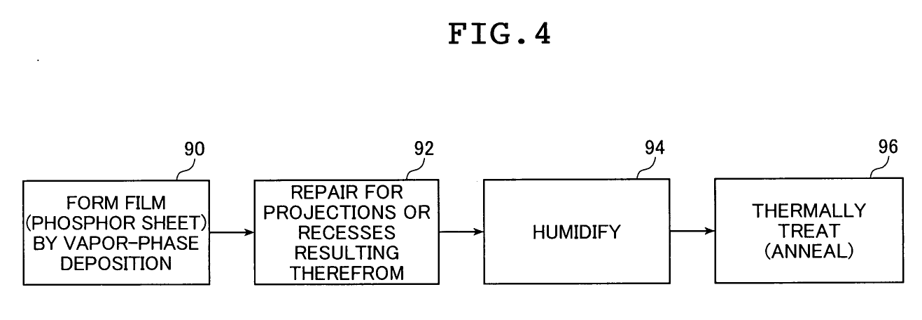

To be more specific, as shown in FIG. 4, upon formation of a phosphor sheet (Step 90), the phosphor sheet is detached from the substrate holder 39 and its surface is checked. Any projections or recesses resulting therefrom as described above are repaired (Step 92). These defects are repaired during the period from the end of the formation of the phosphor layer 72 to the step of first cleaning the surface of the phosphor layer. The surface checking method and the repairing method will be described later in further detail. A predetermined thermal treatment (annealing) is performed in a thermal treatment unit (Step 96).

The sensitivity to irradiation can be enhanced by keeping the phosphor sheet after the end of vapor deposition under predetermined temperature and humidity conditions (hereinafter this treatment is referred to as “humidification”) prior to the thermal treatment. Therefore, it is preferable to humidify the phosphor sheet which has been repaired for the projections or the recesses resulting therefrom in Step 92 under predetermined conditions prior to the thermal treatment (annealing) in the thermal treatment unit. The humidification will be also described later in further detail.

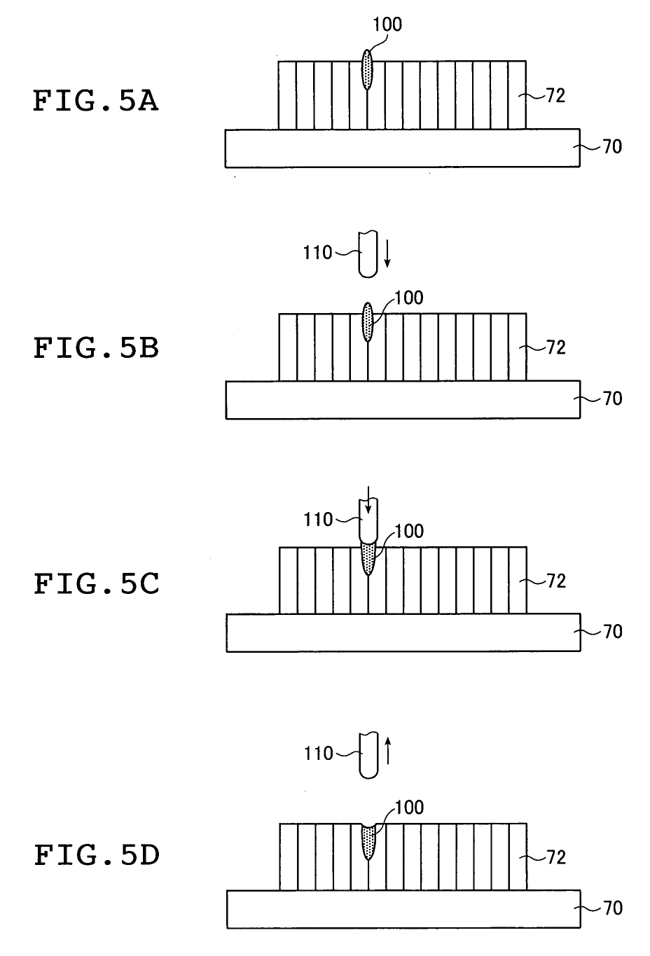

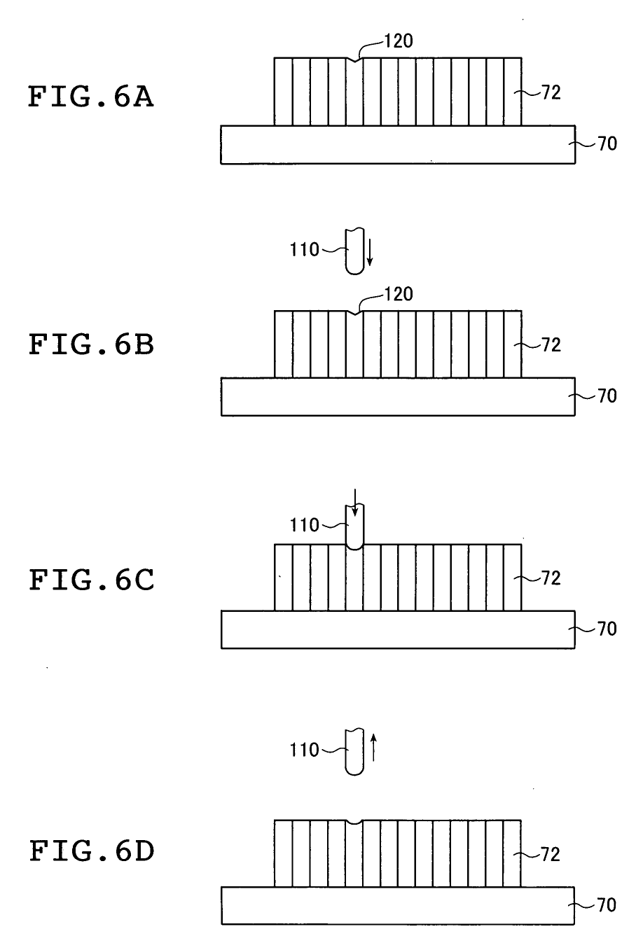

In the following, a description is first given of the repair of the phosphor layer for the projections or the recesses resulting therefrom with reference to FIG. 5A to FIG. 7C. FIGS. 5A to 5D refer to the case where the phosphor layer is repaired by depressing the hillock described above or other projection (hereinafter referred to simply as the “projection”) 100 to flatten out the phosphor layer surface. FIGS. 6A to 6D refer to the case where, when a comparatively small projection or the like comes off to leave a sharply angulated recess 120 behind, the recess 120 is pressed to smooth its surface to thereby repair the phosphor layer.

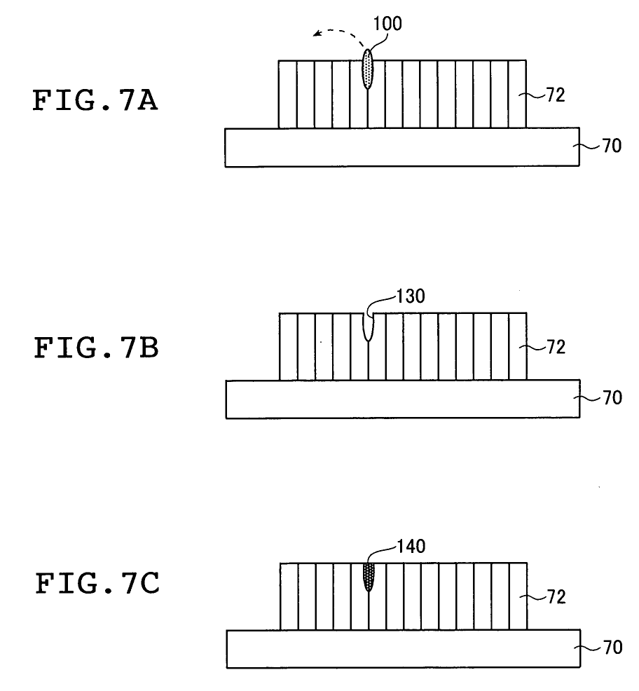

FIGS. 7A to 7C refer to the case where, when the projection 100 having previously existed comes off for some reasons to leave behind a comparatively larger and more sharply angulated recess 130 than the case shown in FIGS. 6A to 6D, the recess is filled with a specified filler to repair the phosphor layer.

In the repairing step to be described below, it is necessary to check the surface of the phosphor sheet (phosphor layer) prior to actually starting the repair in order to locate the existing projection. The check can be advantageously made by, for example, a method in which the phosphor sheet surface is visually checked. Information on the position of the projection that is required for the repair can be obtained by using, for example, a microscope combined with an X-Y table.

Referring first to the example shown in FIGS. 5A to 5D, the surface of the phosphor sheet (hereinafter referred to as the “phosphor layer”) 72 is checked to see whether the phosphor layer 72 has the projection 100. In the case where the presence of the projection 100 was confirmed (see FIG. 5A), a pressing means 110 is set in position (see FIG. 5B) and lowered by applying a predetermined pressing force to the pressing means 110 (see FIG. 5C) to completely bury the projection 100 in the phosphor layer 72. Thereafter, the pressing means 110 is elevated (see FIG. 5D) to end the repair.

The pressing means 110 used is a cylindrical member with one end (lower end in FIGS. 5A to 5D) thereof being in the shape of a hemisphere having a relatively large radius R, say, 10 mm. The pressing means 110 is designed to be slowly pressed downward with a predetermined pressing force applied to the pressing means 110. The speed at the time of pressing the means 110 downward may often be changed depending on the material of the phosphor layer 72 and is therefore preferably determined by the previously conducted experiment.

FIG. 5D shows that the upper surface of the projection 100 that was pushed into the phosphor layer 72 is slightly concave. This is because the lower end of the pressing means 110 has a hemispherical shape. Such a hemispherical shape helps prevent the thickness of the phosphor layer 72 from having abrupt changes.

The case shown in FIGS. 6A to 6D is slightly different from the case shown in FIGS. 5A to 5D, and FIGS. 6A to 6D show the example in which, when a comparatively small projection or the like comes off to leave the sharply angulated recess 120 behind, the recess 120 is pressed downward in the same manner as shown in FIGS. 5A to 5D to smooth the recess surface.

There has not so far been an idea that a comparatively small recess is pressed downward to smooth the recess surface, but in fact, this idea is confirmed to be extremely effective.

In this example, the surface of the phosphor layer 72 is checked to see whether the phosphor layer 72 has the recess 120. In the case where the presence of the recess 120 was confirmed (see FIG. 6A), the pressing means 110 is set in position (see FIG. 6B) and lowered by applying a predetermined pressing force thereto (see FIG. 6C). After the recess 120 in the phosphor layer 72 is smoothed, the pressing means 110 is elevated (see FIG. 6D) to end the repair.

Next, FIGS. 7A to 7C refer to the example in which, when the projection 100 having previously existed comes off for some reasons (see FIG. 7A) to leave behind the comparatively larger and more sharply angulated recess 130 (see FIG. 7B), the recess 130 is filled with a specified filler 140 (see FIG. 7C) to repair the phosphor layer.

Various materials may be used for the filler 140.

More specifically, it is of course preferable to use the material of the phosphor layer 72 for the filler 140, but this is not the sole case of the present invention. It is also possible to use a material having characteristics similar to those of the material of the phosphor layer 72, and also a material of the same type as the material used to form the phosphor layer 72.

A stimulable phosphor may often be used for the filler 140. In such a case, it is preferable to determine the combination of the main component (constituent material of the phosphor layer) and the activator taking into account the sensitivity of the stimulable phosphor to radiation and the wavelength dependence, and the sensitivity of the stimulable phosphor to exciting light used for reading and the luminescence intensity.

A method of filling the recess 130 with the filler 140 is now described.

The filler 140 commonly used is very often in power form. Exemplary methods that may be used include a method of filling the recess 130 with the filler in power form, and a method of filling the recess 130 with the filler dissolved (or dispersed) in a liquid such as a binder.

Although this is a special case, in a phosphor sheet having a phosphor layer made up of columnar crystals as produced by vapor-phase deposition under the medium degree of vacuum, part of a columnar crystal cut in another place may be filled into the recess. In this case, the filling operation (repairing) can be made to achieve extremely high characteristics including excellent engineering characteristics.

The radiation image conversion panel production process in the embodiment under consideration in which a phosphor sheet is formed and the formed phosphor sheet is repaired for projections generated on the surface of the phosphor layer or recesses resulting therefrom has an effect of realizing a radiation image conversion panel that is capable of preventing image quality deterioration on image such as point defects and of providing high-quality images.

As described above, the sensitivity to irradiation can be enhanced by keeping the phosphor sheet after the end of vapor deposition under predetermined temperature and humidity conditions. The inventors of the present invention have quantitatively caught this phenomenon, which afforded a clue to a specific application for enhancing the sensitivity of the phosphor sheet to irradiation.

The reference temperature and humidity conditions deemed to be practically effective are to keep the phosphor sheet for 5 minutes to 1 week in an environment of 20° C. to 50° C. and 30 to 80% RH. It is deemed that these conditions may be influenced by the type of a stimulable phosphor constituting the phosphor sheet, conditions of vapor deposition, and conditions of thermal treatment after the phosphor sheet has been kept in the above-defined environment.

The steps of the radiation image conversion panel production process of this embodiment is described below in further detail with reference to a radiation image conversion panel produced by using the production apparatus 10.

The step of the vapor deposition using the production apparatus 10 in the radiation image conversion panel production process is the same as described above, so a description is given below of the formed radiation image conversion panel (phosphor layer) that has been repaired for the projections or the recesses resulting therefrom.

In order to prevent further adhesion of dirt or dust, the phosphor sheet that has been repaired for the projections or the recesses resulting therefrom by any of the illustrated methods is then subjected to the thermal treatment (annealing) in the thermal treatment unit under the predetermined conditions with a dust-proof cover optionally attached to the phosphor sheet.

After the end of the thermal treatment, the phosphor sheet is allowed to fully cool and is transported to a moisture-proof protective layer-forming device (not shown) in the subsequent step where the moisture-proof protective layer 74 (see FIG. 8) is formed. An adhesive is applied to the phosphor layer 72 using, for example, a dispenser to form an adhesive layer 76.

Then, a moisture-proof protective film, for example, wound in a roll (not shown) is pulled out and applied onto the adhesive layer 76 by heat lamination so that its outer periphery is closely adhered to the upper edge of a frame 70c inserted into a groove 70b of the substrate 70 to form the moisture-proof protective layer 74 (see FIG. 8). The radiation image conversion panel 80 shown in FIG. 8 can be thus produced.

A protective film onto which an adhesive is applied in advance may be used to form the moisture-proof protective layer 74.

The moisture-proof protective film constituting the moisture-proof protective layer 74 may be, for example, a moisture-proof protective film formed of 3 sub-layers on a polyethylene terephthalate (PET) film: an SiO₂ film; a hybrid sub-layer of SiO₂ and polyvinyl alcohol (PVA); and an SiO₂ film. Other examples of the material that may be preferably used include a glass plate (film); a film of resin such as polyethylene terephthalate or polycarbonate; and a film having an inorganic substance such as SiO₂, Al₂O₃, or SiC deposited on the resin film.

For formation of the moisture-proof protective layer 74 having 3 sub-layers of SiO₂ film/hybrid sub-layer of SiO₂ and PVA/SiO₂ film on the PET film, the SiO₂ films may be formed through sputtering and the hybrid sub-layer of SiO₂ and PVA may be formed through a sol-gel process, for example. The hybrid sub-layer is preferably formed to have a ratio of PVA to SiO₂ of 1:1.

The moisture-proof protective layer 74 preferably has a moisture vapor transmission rate of 0.2 to 0.6 g/(m²·day) in an environment of 40° C. and 90% RH.

An additional description is given below of the step of humidification.

After having been formed in the vacuum chamber, the phosphor layer is usually not subjected to a particular treatment but heat-treated (annealed) after the lapse of a predetermined period of time to enhance the sensitivity of the phosphor layer. However, the inventors of the present invention have found that the sensitivity of the phosphor layer can be enhanced by the step of keeping it for 5 minutes to 1 week in an environment of 20° C. to 50° C. and 30% to 80% RH prior to the thermal treatment (in other words, the humidification step) and the basic concept of the inventive process is to substantially incorporate this step thereinto.

While the radiation image conversion panel and the process for producing the radiation image conversion panel according to the present invention have been described above in detail, the present invention is by no means limited to the foregoing embodiments and it should be understood that various improvements and modifications can of course be made without departing from the scope and spirit of the invention.

### EXAMPLES

On the following pages, the present invention is described in greater detail with reference to specific examples. It should of course be understood that the present invention is by no means limited to the following examples.

The production apparatus (apparatus for producing radiation image conversion panels) in the embodiment shown in FIGS. 1A and 1B was used to produce radiation image conversion panels (phosphor sheets).

The radiation image conversion panels (phosphor sheets) shown in the Examples were produced by the common procedure until the end of vapor deposition and the characteristic feature of the process is that the conversion panels were repaired for projections or recesses resulting therefrom after the end of vapor deposition, which has been as described above.

The substrate 70 accommodated in the substrate holder 39 was set in a plasma cleaner. The plasma cleaner was activated to generate an argon plasma in an argon gas atmosphere at a pressure of 1 Pa under the conditions of an electric power of 500 W and a period of 60 seconds to clean the surface of the substrate 70, after which the substrate 70 accommodated in the substrate holder 39 was set in the substrate holding means 26 of the substrate holding and transporting mechanism 14 in the vacuum chamber 12.

Then, a CsBr film-forming material and a EuBr² film-forming material were respectively filled into the crucibles (vessels) 50, 52 for resistance heating in the thermal evaporating section 16 of the vacuum chamber 12.

Cesium bromide (CsBr) powder having a purity of 4 N or more and a molten product of europium bromide (EuBr₂) having a purity of 3N or more were provided as the film-forming materials. In order to prevent oxidation, the molten product of EuBr₂ was prepared by loading the powder into a Pt crucible within a tube furnace that had been fully purged with a halogen gas; the process of preparation included melting by heating to 800° C., cooling and taking out of the furnace. Analysis of trace elements in each of the film-forming materials by ICP-MS (inductively coupled plasma mass spectrometry) showed the following: The alkali metals other than Cs in CsBr (i.e. Li, Na, K, and Rb) were each present in not more than 10 weight ppm whereas other elements such as alkaline earth metals (Mg, Ca, Sr, and Ba) were each present in 2 weight ppm or less; the rare earth elements other than Eu in EuBr₂ were each present in not more than 20 weight ppm and the other elements in 10 weight ppm or less. Since both film-forming materials were highly hygroscopic, they were stored in a desiccator keeping a dry atmosphere with a dew point of −20° C. or lower and taken out just before use.

At a distance of 100 mm from the thermal evaporating section 16, the substrate 70 was linearly transported to form the phosphor layer 72 thereon.

After the CsBr and EuBr₂ film-forming materials were respectively filled into the crucibles (vessels) 50 and 52 for resistance heating, the door 13 of the vacuum chamber 12 was shut to close the vacuum chamber 12. The vacuum pump 18 was activated to evacuate the vacuum chamber 12; at the time when the pressure in the vacuum chamber 12 had reached a predetermined value, say, 8×10⁻⁴ Pa, for example, argon gas was introduced into the vacuum chamber 12 through the opening 19a of the gas introducing nozzle 19 with the evacuating process being continued such that the pressure in the vacuum chamber 12 was adjusted to, for example, 1.0 Pa.

The detailed conditions used in the step of vapor deposition are as follows:

After the end of the substrate treatment, the vacuum chamber 12 was evacuated to a degree of vacuum of 8×10⁻⁴ Pa; then, a predetermined amount of argon gas was introduced to achieve a degree of vacuum of 1.0 Pa.

The film-forming materials (CsBr and EuBr₂) were heated and melted using a resistance heating device with the shutter provided between the substrate 70 and the thermal evaporating section 16 (crucibles 50 and 52) closed. After the lapse of 60 minutes from the start of heating, the shutter over the crucibles 50 was only opened and linear transport of the substrate 70 was started to deposit the CsBr phosphor as the matrix on the surface of the substrate 70.

Then, after the lapse of a predetermined period of time from the opening of the shutter over the crucibles 50, the shutter over the crucibles 52 was also opened to start depositing the CsBr:Eu stimulable phosphor on the CsBr phosphor matrix.

The rate of deposition was set to 6 μm/min. The current in each of the crucibles in the thermal evaporating section 16 was adjusted such that the molarity ratio of Eu/Cs in the stimulable phosphor layer could be 0.003:1.

After the end of vapor deposition, the resistance heating device was turned off and the supply of argon gas was stopped.

Then, nitrogen gas or dry air was introduced into the vacuum chamber 12 to restore atmospheric pressure; then, the door 13 was opened to take out the substrate holder 39 containing the substrate 70 from within the vacuum chamber 12.

On the surface 70d of the substrate 70 was formed the phosphor layer 72 that was of a structure in which columnar phosphor crystals densely grew in an approximately vertical direction. The phosphor layer 72 formed had a thickness of 700 μm and an area of 400 mm×400 mm.

The subsequent treatment steps are shown in detail in FIG. 9, which shows in further detail the steps shown in FIG. 4.

In Step 152 corresponding to Step 92 in FIG. 4, projections (hillocks as described above) generated during vapor deposition (vapor-phase deposition; Step 150 corresponding to Step 90 in FIG. 4) or recesses resulting therefrom were checked and repairs were made before cleaning the surface of the phosphor layer in the subsequent step.

A stainless steel cylinder with one end thereof being in the shape of a hemisphere having a radius R of 4 mm was used for the pressing means 110. The pressing means 110 was pressed at a pressing force of 1.5 kgf and a descending speed of 0.01 m/s.

The repairing step was carried out in a dedicated hermetically sealed case.

After the completion of the repairing step, the phosphor sheet was sent to the surface cleaning step (Step 154). The surface cleaning step was also carried out in a dedicated case.

To be more specific, an air-blowing type, dust removal means was used to clean the surface of the phosphor sheet. The rate of air blown for cleaning was set to 20 m/s.

Then, the phosphor sheet was subjected to the humidification (Step 156 corresponding to Step 94 in FIG. 4). The conditions of the humidification included a temperature of 30° C., a relative humidity of 60 RH and a time period of 6 hours. The humidification step was also carried out in a dedicated case.

Then, the phosphor sheet having undergone the humidification was subjected to a thermal treatment at 200° C. for 2 hours (Step 158 corresponding to Step 96 in FIG. 4) in order to enhance the sensitivity.

In the thermal treatment step, the phosphor sheet was first put in a vacuum heater into which a gas could be introduced. The vacuum heater was evacuated to about 1 Pa by a rotary pump, and moisture adsorbed on the phosphor sheet was removed.

Then, the vacuum heater was heated and N₂ (nitrogen) gas was flowed into the vacuum heater to place it in a N₂ gas flow atmosphere. As described above, the thermal treatment was carried out under the thermal treatment conditions of a temperature of 200° and a time period of 2 hours. After the thermal treatment, the phosphor sheet was taken out of the vacuum heater and allowed to cool in the air.

Then, after cleaning the surface of the phosphor sheet (Step 160), the phosphor sheet was sent to the polishing step (Step 162). After the end of the polishing step, the surface of the phosphor sheet was cleaned again (Step 164) to carry out processing for a radiation image conversion panel (Step 166).

In the processing step for a radiation image conversion panel to be produced, for example, a dispenser was used to apply an adhesive to the region of the phosphor sheet where the phosphor layer 72 was not formed.

Then, a moisture-proof protective film wound in a roll was pulled out and applied onto the phosphor layer 72 by heat lamination so that its outer periphery was closely attached to the surface of the substrate, thus forming the moisture-proof protective layer 74.

The radiation image conversion panel was thus produced.

In the Examples, a solid image was obtained as a radiation image from each of the radiation image conversion panels produced as described above and checked to see whether there were point defects.

A description is given below of the method of inspecting the radiation image (solid image) obtained from the radiation image conversion panel for point defects.

A tungsten tube was used to expose the entire surface of the radiation image conversion panel to about 10 mR (2.58×10⁻⁶ C/kg) of X-rays at a tube voltage of 80 kVp. After the exposure to X-rays, an image reader of a line scanner type (the radiation image conversion panel was irradiated with semiconductor laser light having a wavelength of 660 nm; photostimulated luminescence emitted from the surface of the radiation image conversion panel was received by a CCD sensor having linearly arranged light receiving elements) was used to read the photostimulated luminescence; the thus read (received) photostimulated luminescence was converted into an electric signal, thus obtaining the solid image as the radiation image; a film having the radiation image (solid image) reproduced as a visible image was output by a laser printer.

Then, for each of the radiation image conversion panels, a resulting radiation image (solid image) recorded on the film was visually checked on a film viewer to see whether there were dropouts (point defects) in the central area of the radiation image (solid image) measuring 10 cm×10 cm (10 cm square; 100 cm²). The number of point defects was thus counted.

Ten radiation image conversion panels were checked and as a result, the number of point defects was 0 to 2 per panel and it was confirmed that every radiation image conversion panel was of a high enough quality for practical use.

As described above, a radiation image conversion panel that provides a high-quality image with fewer defects could be produced according to the radiation image conversion panel production process of the present invention.

What is claimed is:

1. A radiation image conversion panel comprising:
a substrate; and
a phosphor layer formed on said substrate by vapor-phase deposition in a vacuum chamber, said phosphor layer being repaired for projections generated on a surface of said phosphor layer or recesses resulting therefrom.

2. A process for producing a radiation image conversion panel comprising:
a step of forming a phosphor layer on a substrate by vapor-phase deposition in a vacuum chamber;
a step of repairing said phosphor layer for projections generated on a surface of said phosphor layer or recesses resulting therefrom; and
a step of subjecting said phosphor layer to a thermal treatment to obtain said radiation image conversion panel.

3. The process according to claim 2, further comprising: a cleaning step for cleaning the surface of said phosphor layer, said formed phosphor layer being repaired before being subsequently subjected to said cleaning step.

4. The process according to claim 2, wherein said phosphor layer is repaired for said projections or said recesses resulting therefrom by pressing said projections or recesses from above.

5. The process according to claim 4, wherein said phosphor layer is repaired for said projections or said recesses resulting therefrom by using a tool whose tip portion has a curved surface.

6. The process according to claim 5, wherein the tip portion of said tool used has a hemispherical surface.

7. The process according to claim 6, wherein the tip portion of said tool has a hemispherical surface with a radius of 1 mm to 10 mm.

8. The process according to claim 2, wherein said phosphor layer is repaired by removing said projections and filling holes resulting therefrom with a specified filler.

9. The process according to claim 8, wherein a certain or predetermined phosphor is used for said specified filler when the holes are filled to repair said phosphor layer.

10. The process according to claim 9, wherein a phosphor of a type identical to said material constituting said phosphor layer formed is used for said certain or predetermined phosphor.

11. The process according to claim 8, wherein said specified filler is used in a powder state.

12. The process according to claim 8, wherein said specified filler is used in a state in which said specified filler is dissolved in a binder.

13. The process according to claim 8, wherein, when said phosphor layer formed is made up of columnar crystals, a columnar crystal in another position is used for said specified filler.

14. The process according to claim 2, wherein said phosphor layer is a phosphor layer comprising a stimulable phosphor.

15. The radiation image conversion panel according to claim 1, further comprising: a moisture-proof protective layer formed on said phosphor layer.

16. The process according to claim 8, further comprising: a step of forming a moisture-proof protective layer on said phosphor layer having undergone said thermal treatment.
